(19) United States
(12) Patent Application Publication
(10) Pub. No.: US 2023/0182005 A1
(43) Pub. Date: Jun. 15, 2023

(54) CONTROLLING MULTICOMPUTER INTERACTION WITH DEEP LEARNING AND ARTIFICIAL INTELLIGENCE

(71) Applicant: BOARD OF REGENTS, THE UNIVERSITY OF TEXAS SYSTEM, Austin, TX (US)

(72) Inventors: Aaron M. Tate, Dallas, TX (US); Maria T. Johnson, Frisco, TX (US); Kamin L. Bouguyon, Rowlett, TX (US)

(73) Assignee: BOARD OF REGENTS, THE UNIVERSITY OF TEXAS SYSTEM, Austin, TX (US)

(21) Appl. No.: 17/548,887

(22) Filed: Dec. 13, 2021

(51) Int. Cl. A63F 13/23; A63F 13/825; G06N 3/02

(52) U.S. Cl. CPC A63F 13/23; A63F 13/825; G06N 3/02

(57) ABSTRACT

A system for controlling multicomputer interaction with deep learning is disclosed that includes a controller system that is configured to generate one or more first user-controllable avatars on an interaction field, where the first avatars include movement controls and prompt functionality that is controllable by a first user to cause the first avatar to generate a prompt. A client system is configured to generate a second user-controllable avatar on the interaction field, where the second avatar includes movement controls and response functionality that is controllable by a second user to cause the second avatar to generate a response to the prompt. A deep learning processing system is configured to receive the prompt and the response and to process the prompt and the response to generate a score and to assign the score to one of two or more categories associated with the second user.

### TECHNICAL FIELD

The present disclosure relates generally to control of multicomputer interactions, and more specifically to the control of multicomputer interactions with artificial intelligence and deep learning systems.

### BACKGROUND OF THE INVENTION

Systems, such as gaming systems, allow users to interact with each other using avatars, but such interactions are generally incidental to game objectives.

### SUMMARY OF THE INVENTION

A system for controlling multicomputer interaction with deep learning is disclosed that includes a controller system that is configured to generate one or more first user-controllable avatars on an interaction field, where the first avatars include movement controls and prompt functionality that is controllable by a first user to cause the first avatar to generate a prompt. A client system is configured to generate a second user-controllable avatar on the interaction field, where the second avatar includes movement controls and response functionality that is controllable by a second user to cause the second avatar to generate a response to the prompt. A deep learning processing system is configured to receive the prompt and the response and to process the prompt and the response to generate a score and to assign the score to one of two or more categories associated with the second user.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for controlling multicomputer interaction with deep learning and artificial intelligence, in accordance with an example embodiment of the present disclosure;

FIG. 2 is a diagram of a system for providing avatar controls, in accordance with an example embodiment of the present disclosure;

FIG. 3 is a diagram of a system for providing coach feedback controls, in accordance with an example embodiment of the present disclosure;

FIG. 4 is a diagram of an algorithm for control of multicomputer interaction with deep learning and artificial intelligence, in accordance with an example embodiment of the present disclosure; and

FIG. 5 is a diagram of an algorithm for control of multicomputer interaction with deep learning and artificial intelligence, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

Multicomputer systems can be used for many applications where control is not an issue, such as for commercial transactions or banking. The present disclosure is directed to multicomputer systems that are used to facilitate interaction between users as well as to apply deep learning to those interactions, such as where a user can provide metadata in real time with data from the interactions themselves as input to train a deep learning process (where neural networks, artificial intelligence or other suitable automated or algorithmic learning processes are generally referred to herein as “deep learning”). Such interactions are unlike commercial transactions or banking, because the content of the transactions themselves are of interest as opposed to making a purchase or accessing a financial account. Thus, while the fact that a user made a purchase or performed a transaction might be the focus of a commercial transaction or banking transaction, the present disclosure is directed to the content of the interactions between multiple users, how that content can be augmented using artificial intelligence or deep learning, and how the augmented content can be used in a feedback mode to improve the accuracy of the artificial or deep learning processes for those interactions, among other useful systems and methods as discussed further herein.

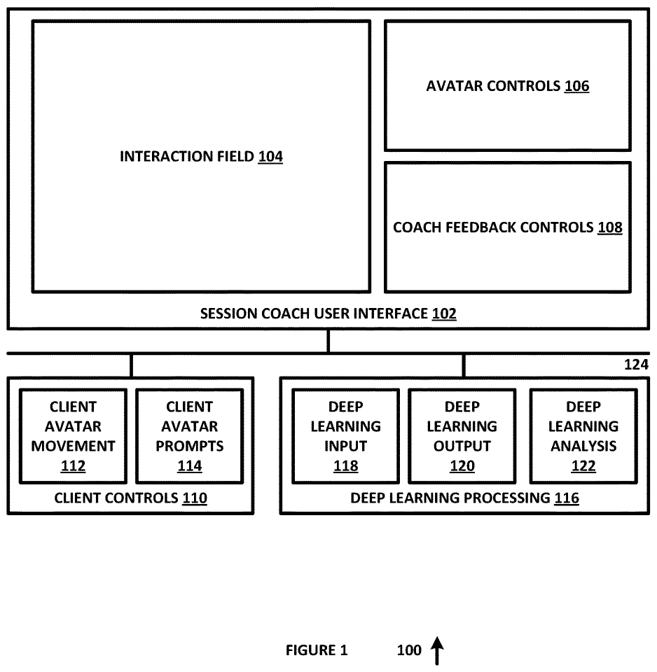

FIG. 1 is a diagram of a system 100 for controlling multicomputer interaction with deep learning and artificial intelligence, in accordance with an example embodiment of the present disclosure. System 100 includes session coach user interface 102, interaction field 104, avatar controls 106, coach feedback controls 108, client controls 110, client avatar movement 112, client avatar prompts 114, deep learning processing 116, deep learning input 118, deep learning output 120 and deep learning analysis 122, which can be arranged as shown or in other suitable arrangements, and which can be interconnected over network 124 and implemented in hardware or a suitable combination of hardware and software.

Session coach user interface 102 can be implemented as one or more algorithms operating on a suitable processing platform that can be loaded into a working memory of the processing platform to cause the processing platform to generate a session coach user interface or other suitable user interfaces for controlling multicomputer interaction with deep learning and artificial intelligence. In this example embodiment, a session coach is the primary controller, but other suitable embodiments can also or alternatively be used, such as classrooms, seminars, meetings or other applications where interaction between users occurs and requires multicomputer interaction with deep learning and artificial intelligence, as discussed further herein. In another example embodiment, session coach user interface 102 can be used in conjunction with one or more screen displays, a head mounted user interface, a virtual reality user interface, an augmented reality user interface or other suitable user interfaces.

Interaction field 104 can be implemented as one or more algorithms operating on a suitable processing platform that can be loaded into a working memory of the processing platform to cause the processing platform to generate an interaction field with a plurality of interaction controls. In one example embodiment, a session coach can control the number and functionality of the interaction controls, such as by identifying avatars, objects or other display items that a user can interact with. In this example embodiment, a client can be presented with the opportunity to select one of two or more actions, such as to open a door or to interact with the coach, where the controls for the door or coach interactions are controlled by the coach. In other example embodiments, a group of clients can be allowed to interact with a coach one at a time, where there is one active client and a plurality of standby clients that are queued for interaction in order, the clients can compete to find an object or other suitable functions can also or alternatively be provided. Likewise, interaction controls can initially be generated by deep learning processing 116 and can be subsequently controlled by a coach, a client, deep learning processing 116 or in other suitable manners. Interaction controls 116 provide the technical feature of generating metadata for use in deep learning processing 116 or for other suitable purposes in real time, to improve the deep learning training process and for other purposes. For example, deep learning can be integrated into system 100, such as in the form of proposed avatar attributes, proposed scoring attributes and in other suitable manners.

Avatar controls 106 can be implemented as one or more algorithms operating on a suitable processing platform that can be loaded into a working memory of the processing platform to cause the processing platform to control one or more avatars in interaction field 104. In one example embodiment, avatar controls 106 can allow a user to select an avatar, to configure an avatar, to cause an avatar to move, to cause the avatar to generate user-entered statements, to cause the avatar to generate statements generated by deep learning processing 116 or to perform other suitable functions. In this example embodiment, avatar controls 106 can be generated on a screen that is separate from the screen that is used to generate interaction field 104 or coach feedback controls 108 to facilitate the ability of the coach to keep those functions separate and to avoid inadvertent entry of input intended for one system from being provided to a different system. Likewise, in a virtual or augmented environment, avatar controls 106 can be located in a different virtual location, can be accessed using a different virtual control or other suitable functions can also or alternatively be provided.

Coach feedback controls 108 can be implemented as one or more algorithms operating on a suitable processing platform that can be loaded into a working memory of the processing platform to cause the processing platform to generate one or more controls for receiving feedback from a coach. In one example embodiment, a coach can select questions and answers, interactions with a client, metadata associated with the interactions that identifies characteristics of the interaction or other suitable data for provision to deep learning processing 116 or other suitable systems, to provide the technical feature of real-time augmentation of deep learning input to facilitate use and analysis of the data. In another example embodiment, coach feedback controls 108 can include a scoring mechanism that allows the coach to review the progress that a client has made towards a plurality of goals and to update the scoring mechanism whenever the client accomplishes a goal. The scoring mechanism can select one or more prior interactions with the client for use in assessing how that interaction resulted in the associated goal being met, to input that interaction data into deep learning processing 116 for analysis or can perform other suitable functions.

Client controls 110 can be implemented as one or more algorithms operating on a suitable processing platform that can be loaded into a working memory of the processing platform to cause the processing platform to generate a client user interface or other suitable user interfaces for controlling multicomputer interaction with deep learning and artificial intelligence. In this example embodiment, a client can have limited functionality control but can respond to prompts from a coach, select controls that have been defined by a coach for deep learning processing 116, metadata associated with the client actions or responses that identifies characteristics of the interaction or other suitable data for provision to deep learning processing 116 or other suitable systems, to provide the technical feature of real-time augmentation of deep learning input to facilitate use and analysis of the data, or can perform other suitable functions, as discussed further herein. In another example embodiment, client controls 110 can be used in conjunction with one or more screen displays, a head mounted user interface, a virtual reality user interface, an augmented reality user interface or other suitable user interfaces.

Client avatar movement 112 can be implemented as one or more algorithms operating on a suitable processing platform that can be loaded into a working memory of the processing platform to cause the processing platform to control movement of an avatar for a client. In one example embodiment, the avatar can have a plurality of user-selectable movement options, such as to allow the avatar to approach different objects, enter different virtual rooms or perform other functions. The avatar movement controls can be selected or modified by the coach, deep learning processing 116 or in other suitable manners, and the client response to a modification to the controls can be used as input to deep learning processing 116 to confirm or modify predictions made by deep learning processing 116 or for other suitable purposes.

Client avatar prompts 114 can be implemented as one or more algorithms operating on a suitable processing platform that can be loaded into a working memory of the processing platform to cause the processing platform to generate client avatar prompts and to receive client avatar responses. In one example embodiment, client avatar prompts 114 can include a text to speech converter for prompts, a speech to text converter for responses, an audio recorder or other suitable functions that allow the specific interactions of the client with the coach to be recorded and analyzed. Client avatar responses can also be associated with score, questions generated by avatar controls 106, feedback generated by coach feedback controls 108 or other suitable functions, to facilitate the use of client avatar prompts and responses by system 100.

Deep learning processing 116 can be implemented as one or more algorithms operating on a suitable processing platform that can be loaded into a working memory of the processing platform to cause the processing platform to receive inputs from session coach user interface 102 and client controls 110, to analyze the inputs, to generate outputs to session coach user interface 102 and client controls 110 and to perform other suitable functions. In one example embodiment, deep learning processing 116 can be used to process data in real time, so as to generate suggested prompts for a coach during a session, to generate suggested responses to questions for a lecturer or for other suitable purposes. In another example embodiment, deep learning processing 116 can analyze data after completion of a session and can generate scoring suggestions or other data for use by a session coach, such as for a future session.

Deep learning input 118 can be implemented as one or more algorithms operating on a suitable processing platform that can be loaded into a working memory of the processing platform to cause the processing platform to receive input from client controls 110, session coach user interface 102 or other suitable input. In one example embodiment, deep learning input 118 can receive selected inputs as a function of controls from a session coach, can perform data mining on continuous input from client controls 110 and session coach user interface 102 or can receive other suitable data. Deep learning input 118 can include metadata associated with coach or client statements, control selections or other interactions, where the metadata includes selected or user-entered data fields that identify characteristics of associated training data or other suitable data for provision to deep learning processing 116 or other suitable systems, to provide the technical feature of real-time augmentation of deep learning input to facilitate use and analysis of the data. Deep learning input 118 thus provides the technical feature of solving a previously unidentified problem, namely, that inputs and outputs of a deep learning processor are often not strongly correlated for use in training. For example, a key part of a prompt for use in deep learning input could occur several statements before a reply to the prompt is received, and deep learning input 118 allows a user to indicate the training data and metadata that should be used, the expected outputs to that data and metadata input and other suitable data for use in training a deep learning system, a neural network, artificial intelligence or other suitable systems.

Deep learning output 120 can be implemented as one or more algorithms operating on a suitable processing platform that can be loaded into a working memory of the processing platform to cause the processing platform to generate one or more outputs to client controls 110, session coach user interface 102 or other suitable systems. In one example embodiment, deep learning output 120 can generate one or more suggested prompts for a coach in response to a statement or input from a client, a selected objective, or other suitable inputs. In this example embodiment, deep learning output can process data and generate a list of proposed responses, a list of proposed action items in response to a request from a coach for suggested action items, one or more controls for client controls 110 or other suitable data.

Deep learning analysis 122 can be implemented as one or more algorithms operating on a suitable processing platform that can be loaded into a working memory of the processing platform to cause the processing platform to analyze deep learning inputs and outputs. In one example embodiment, deep learning, artificial intelligence, neural networks or other suitable processes can be trained to generate responses to inputs, and to predict further input that is expected to those responses. Deep learning analysis 122 can receive the further input and can determine whether the further input matches what was predicted. The results of whether or not the further input was predicted can be used to update future responses. Likewise, deep learning analysis 122 can receive input from a coach, such as when a coach selects one of two or more proposed prompts, when a coach does not select any proposed prompt and instead generates a different prompt, a score generated by a coach that is the same or different from a proposed score or other suitable data, and can use the data to improve the predictions and guidance that is generated.

In operation, system 100 provides for control of multicomputer interaction with deep learning and artificial intelligence, such as by allowing user interactions in a multicomputer environment to be based on suggested inputs, to receive actual responses and to determine whether the actual responses correlated with the expected responses, to generate score and to modify scoring algorithms based on actual score and for other suitable purposes.

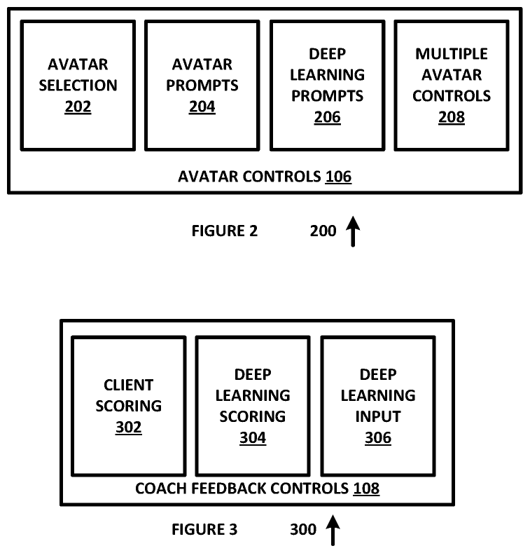

FIG. 2 is a diagram of a system 200 for providing avatar controls, in accordance with an example embodiment of the present disclosure. System 200 includes avatar controls 106 and avatar selection 202, avatar prompts 204, deep learning prompts 206 and multiple avatar controls 208, which can be arranged as shown or in other suitable arrangements, and which can be interconnected over network 124 and implemented in hardware or a suitable combination of hardware and software.

Avatar selection 202 can be implemented as one or more algorithms operating on a suitable processing platform that can be loaded into a working memory of the processing platform to cause the processing platform to generate a plurality of avatars for selection by a coach, such as by including predetermined behavioral characteristics for each avatar, by identifying specific objectives associated with each avatar or in other suitable manners. In one example embodiment, a user can identify a set of objectives for a coaching session, such as “avoid getting angry,” “be more assertive” or other suitable objectives. Avatar selection 202 can generate suggested avatars for the identified objectives, in addition to guidance on the specific objectives that each avatar can be used for. Avatar selection 202 further generates controls to allow a user to select a sequence of one or more avatars, to control avatar functionality (such as rooms that the avatar is in) or other suitable functions.

Avatar prompts 204 can be implemented as one or more algorithms operating on a suitable processing platform that can be loaded into a working memory of the processing platform to cause the processing platform to generate prompts for use by a coach, such as where a speech converter is used to allow a coach to assume a role of an avatar, where the coach enters text that an avatar will speak using a text to voice processor, by presenting a menu of proposed responses or in other suitable manners. Avatar prompts 204 can also be used to process a proposed response from an avatar and to provide real-time suggestions on how to modify the response to conform to behavioral attributes of the avatar, such as to prevent a coach from inadvertently falling out of character with the avatar.

Deep learning prompts 206 can be implemented as one or more algorithms operating on a suitable processing platform that can be loaded into a working memory of the processing platform to cause the processing platform to generate deep learning prompts, such as suggestions for the coach to repeat or modify in response to objectives, client responses, user interface control modifications or for other suitable purposes. In one example embodiment, deep learning prompts 206 can include specific prompts for an avatar based on associated objectives, with guidelines for scoring a client response to the prompt or other suitable data. In another example embodiment, deep learning prompts 206 can be generated by a deep learning processor in response to real time dialog or in other suitable manners.

Multiple avatar controls 208 can be implemented as one or more algorithms operating on a suitable processing platform that can be loaded into a working memory of the processing platform to cause the processing platform to generate multiple avatar controls, such as when the coach selects two or more avatars to interact in a specific manner. In one example embodiment, two avatars can be selected to provide a good example of an interaction, such as for responding to criticism or anger. In this example, one avatar can be provided with negative or unacceptable behavior prompts, and the second avatar can be provided with positive or acceptable behavior prompts. A coach user interface control can be used to allow a coach to vary the response, to demonstrate incrementally better or worse behavior, or for other suitable purposes.

In operation, system 200 allows avatars to be controlled by a coach or other primary user, such as to allow the avatars to provide responses to clients that reinforce behavioral objectives, to demonstrate examples of acceptable and unacceptable behavior or other suitable functions.

FIG. 3 is a diagram of a system 300 for providing coach feedback controls, in accordance with an example embodiment of the present disclosure. System 300 includes coach feedback 108 and client scoring 302, deep learning scoring 304 and deep learning input 306, which can be arranged as shown or in other suitable arrangements, and which can be interconnected over network 124 and implemented in hardware or a suitable combination of hardware and software.

Client scoring 302 can be implemented as one or more algorithms operating on a suitable processing platform that can be loaded into a working memory of the processing platform to cause the processing platform to generate a score for a client. In one example embodiment, the client score can be generated in response to client responses to prompts, where the prompts are associated with a specific scoring component. In this example embodiment, the coach can generate a score based on one or more client responses, the client responses can be processed in real time by an artificial intelligence processor to generate suggested scores or other suitable processes can also or alternatively be used.

Deep learning scoring 304 can be implemented as one or more algorithms operating on a suitable processing platform that can be loaded into a working memory of the processing platform to cause the processing platform to process deep learning scores and whether a coach accepts or declines a deep learning score. In one example embodiment, a coach can be presented with a suggested score for an objective in response to processing of real time interactions with a client, and deep learning scoring 304 can be used to determine whether the score was entered or rejected. In this example embodiment, if a score is rejected, the coach can be prompted to provide additional information regarding why the proposed score was rejected, to improve the scoring function of the deep learning processor.

Deep learning input 306 can be implemented as one or more algorithms operating on a suitable processing platform that can be loaded into a working memory of the processing platform to cause the processing platform to allow a user to identify input for a deep learning process. In one example embodiment, a deep learning processor can have a training mode of operation where inputs are used to update data processing algorithms. Deep learning input 306 allows a user to identify specific interactions between parties for use in training mode, such as examples of proper responses to prompts, improper responses to prompts, examples of proper scoring suggestions, examples of improper scoring suggestions and so forth.

In operation, system 300 allows a coach or other suitable user to provide feedback to a client scoring system, deep learning systems or other suitable feedback. The feedback can include data fields associated with interactions between a coach and a client, a teacher and a student, meeting or conference attendees or other suitable parties, as well as metadata associated with the timing, characteristics or other suitable metadata that can be obtained in real time by a user and used to improve the training of a deep learning system as discussed further herein.

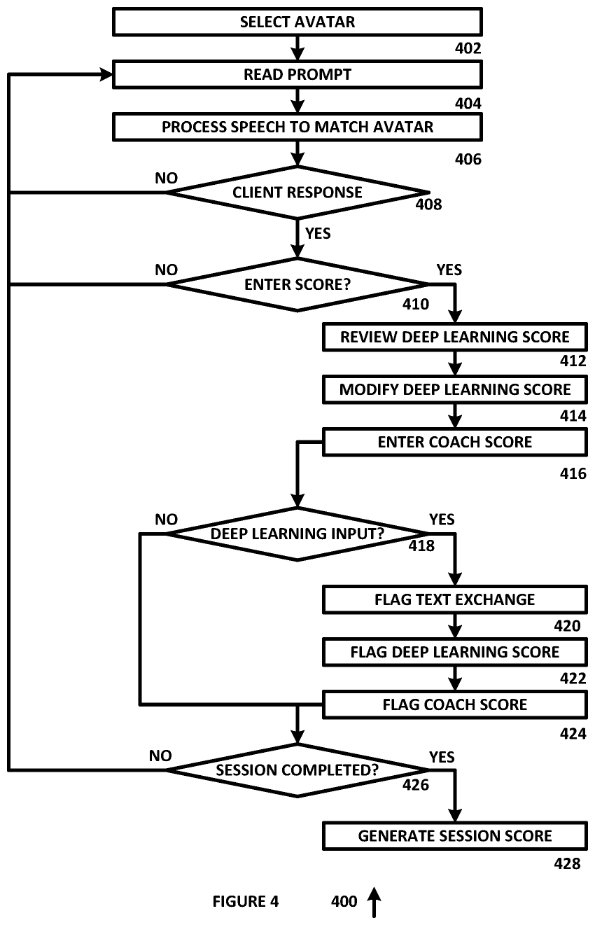

FIG. 4 is a diagram of an algorithm 400 for control of multicomputer interaction with deep learning and artificial intelligence, in accordance with an example embodiment of the present disclosure. Algorithm 400 can be implemented in hardware or a suitable combination of hardware and software.

Algorithm 400 begins at 402, where an avatar is selected. In one example embodiment, the avatar can be selected from a set of avatars having associated behavioral characteristics, learning objectives or other suitable functional attributes that are associated with a specific avatar, such as for the purpose of coaching, instruction and other suitable functions. The algorithm then proceeds to 404.

At 404, a prompt is read. In one example embodiment, the prompt can be selected from a list of suggested prompts, the prompt can be generated by a coach with suitable training and knowledge of behavioral attributes of an avatar or other suitable prompts can be used. The algorithm then proceeds to 406.

At 406, the prompt is processed to generate speech that matches the associated avatar. In one example embodiment, a coach can speak a prompt and the voice signals can be processed to make the voice sound like a different person, such as where the coach is providing counseling and wants to portray specific behavioral attributes for an avatar to a client without stepping out of the role of the coach. In another example embodiment, prerecorded segments can be selected, text to speech processing can be used to generate voice signals from text or other suitable processes can also or alternatively be used. The algorithm then proceeds to 404.

At 408, it is determined whether a client response has been received. If it is determined that a client response has not been received, the algorithm returns to 404, otherwise the algorithm proceeds to 410.

At 410, it is determined whether a score has been entered. If a score has not been entered, the algorithm returns to 404, otherwise the algorithm proceeds to 412.

At 412, a deep learning score is displayed and reviewed. In one example embodiment, the deep learning score can be machine generated, the deep learning score can be selected from a list based on a similarity of a client response to a response on the list or other suitable processes can also or alternatively be used. The algorithm then proceeds to 414.

At 414, the deep learning score is modified. In one example embodiment, a user can indicate that the deep learning score was incorrect, and that indication can be used as metadata input to improve the accuracy of the deep learning system. Likewise, other suitable processes can also or alternatively be used. The algorithm then proceeds to 416.

At 416, a coach score is entered. In one example embodiment, the coach score can be in addition to the deep learning score, can include non-numerical scoring components such as metadata fields, textual analyses or other suitable processes can also or alternatively be used. The algorithm then proceeds to 418.

At 418, it is determined whether deep learning input has been selected. If it is determined that deep learning input has not been selected, the algorithm proceeds to 426, otherwise the algorithm proceeds to 420.

At 420, a text exchange is flagged for entry into a deep learning system. In one example embodiment, the text exchange can include one or more queries from a coach and responses from a client that the coach has selected to be used to indicate a correct response, an incorrect response, a response that indicates a particular condition, metadata or other suitable input for training a deep learning system. The input can include additional metadata tags associated with the deep learning process, such as metadata tags that indicate the relevant portions of the text exchange, that the text exchange has certain attributes, or other suitable metadata. as discussed above. The algorithm then proceeds to 422.

At 422, a deep learning score is flagged. In one example embodiment, a deep learning score that is outside of a reasonable estimate can be flagged by a user to update the deep learning algorithm, such as to provide an input with the indication of whether the score is too low, too high, what the score should be, whether the score was received before scoring was complete and so forth. With the additional input, the deep learning algorithm can be trained to provide a more correct score in the future. The algorithm then proceeds to 424.

At 424, a coach score is flagged. In one example embodiment, the coach score can be flagged when it varies from a deep learning score, when a user wants the score and the basis for the score to be provided for training the deep learning process or for other suitable purposes. The algorithm then proceeds to 426.

At 426, it is determined whether the session has been completed. In one example embodiment, completion of the session can occur after a predetermined period of time, when a user has selected a control, when a session score has been entered or in other suitable manners. Session completion can also cause training data to be submitted to the deep learning system, such as to allow a user to review the material before submitting it, to indicate that it should not be submitted with session completion or in other suitable manners. If it is determined that the session has not been completed, the algorithm returns to 404, otherwise the algorithm proceeds to 428.

At 428, a session score is generated. In one example embodiment, the session score can include an overall deep learning score and overall user score, score components for different segments of the session (such as communication, progress, participation and so forth), or other suitable score.

In operation, algorithm 400 provides for control of multicomputer interaction with deep learning and artificial intelligence. While algorithm 400 is shown with specific steps in a specific flowchart order, a person of skill in the art will understand that the order of functions can be changed, modified, additional functions can be added and certain steps can be omitted without departing from the inventive features. Likewise, algorithm 400 can be implemented using object-oriented programming, a ladder diagram, a state diagram, other suitable programming conventions or in other suitable manners.

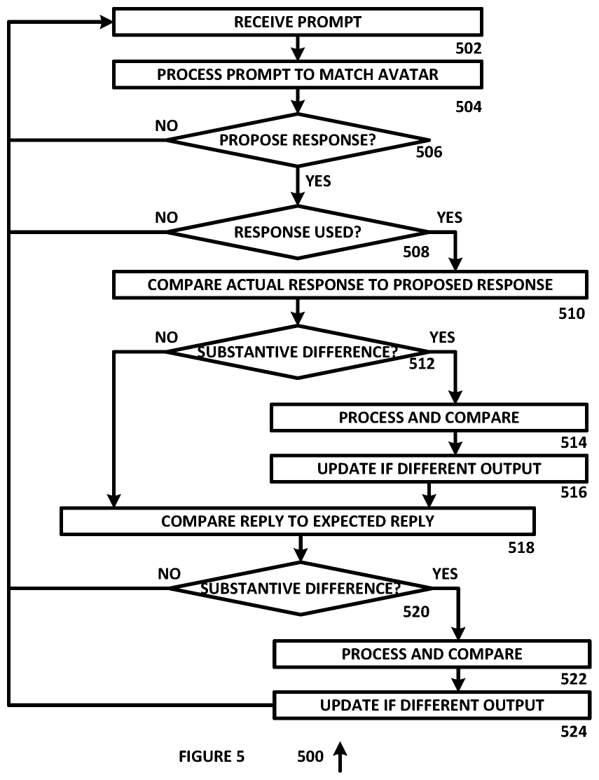

FIG. 5 is a diagram of an algorithm 500 for control of multicomputer interaction with deep learning and artificial intelligence, in accordance with an example embodiment of the present disclosure. Algorithm 500 can be implemented in hardware or a suitable combination of hardware and software.

Algorithm 500 begins at 502 where a prompt is received. In one example embodiment, the prompt can be entered by a coach for a predetermined avatar, such as by selecting a prompt from a list of proposed prompts, entering text, speaking or in other suitable manners. The algorithm then proceeds to 404.

At 504, the prompt is processed to match an avatar. In one example embodiment, a user can recite the prompt and the recited prompt can be processed to create a voice sound having predetermined frequency characteristics, to create the appearance of a different speaker to a client. In another example embodiment, a deep learning process can be used that generates prompts that match personality characteristics of an avatar, such as to match an age, education level, personality trait or other suitable personality characteristics. In this example embodiment, a proposed word in the response can be replaced with a different word that has the same meaning but which reflects a higher or lower education level, an older or younger person and so forth. The algorithm then proceeds to 506.

At 506, it is determined whether a response is proposed. In one example embodiment, the response can be proposed after a reply has been received from a user, such as after processing the reply from the user with a deep learning system, an artificial intelligence system or in other suitable manners. Likewise, if the reply from the user cannot be processed due to a signal error or for some other reason, the user can be prompted to repeat their reply. If it is determined that a response is not proposed, then the algorithm proceeds to 502, otherwise the algorithm proceeds to 508.

At 508, it is determined whether a proposed response has been used. In one example embodiment, the decision by a user not to use a proposed response can result in the delivery of a user-entered response, updating a learning algorithm for a deep learning process with metadata to reflect that the proposed response was not used or other suitable processes can be implemented. If it is determined that the proposed response has not been used, the algorithm returns to 502, otherwise the algorithm proceeds to 510.

At 510, the actual response is compared to a proposed response. The algorithm then proceeds to 512.

At 512, it is determined whether there is a substantive difference between the actual response and the proposed response. In one example embodiment, the response from the user can be processed grammatically and compared to a proposed response, to determine whether any variations between the proposed response and the received response are substantive or otherwise change the meaning of the response, and proposed modifications can be generated. If no substantive difference is detected, the algorithm proceeds to 518, otherwise the algorithm proceeds to 514.

At 514, the substantive differences are processed to determine whether a meaning has changed and are compared to an intended meaning. In one example embodiment, the user can be notified that the meaning between the proposed response and the actual response has been detected, and the user can respond with an indication of whether or not the assessment is correct, such as for training a deep learning process, to provide metadata tags for such training or for other suitable purposes. The algorithm then proceeds to 516.

At 516, a deep learning algorithm is updated if the substantive difference exists and was intended. In one example embodiment, a training input can be generated for a deep learning algorithm, a neural network, or other suitable processes can be used. The algorithm then proceeds to 518.

At 518, a reply to the prompt is processed to determine whether it is an expected reply. In one example embodiment, a yes or no question can be processed to determine whether the answer is yes, no or something else. Likewise, a prompt can have a number of predetermined expected responses, such as “good,” “bad,” a number or other expected responses that can be determined in advance. The algorithm then proceeds to 520.

At 520, it is determined whether a substantive difference has been identified. If no substantive difference has been identified, the algorithm returns to 502, otherwise the algorithm proceeds to 522.

At 522, the reply is processed and compared to the expected reply. In one example embodiment, a user can indicate with metadata tags whether the reply was acceptable even if is not substantively equivalent to an expected reply, the response can be categorized by the user into one of a plurality of predetermined metadata tag categories (such as acceptable, unacceptable, non-cooperative and so forth). The algorithm then proceeds to 404.

At 524, an update to deep learning algorithm or other suitable system is generated if the reply was different from an expected reply. In one example embodiment, the update can include data and associated metadata, can be scheduled for later application, the update can be submitted after it has been approved by a user or other suitable processes can also or alternatively be used.

In operation, algorithm 500 provides for control of multicomputer interaction with deep learning and artificial intelligence. While algorithm 500 is shown with specific steps in a specific flowchart order, a person of skill in the art will understand that the order of functions can be changed, modified, additional functions can be added and certain steps can be omitted without departing from the inventive features. Likewise, algorithm 500 can be implemented using object-oriented programming, a ladder diagram, a state diagram, other suitable programming conventions or in other suitable manners.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A system for controlling multicomputer interaction with deep learning, comprising:
a controller system operating on a first processor and configured to generate one or more first user-controllable avatars on an interaction field, the first avatars including movement controls and prompt functionality that is controllable by a first user to cause the first avatar to generate a prompt;
a client system operating on a second processor and configured to generate a second user-controllable avatar on the interaction field, the second avatar including movement controls and response functionality that is controllable by a second user to cause the second avatar to generate a response to the prompt; and
a deep learning processing system operating on a third processor and configured to receive the prompt and the response and to process the prompt and the response to generate a score as a function of the prompt and the response and to assign the score to one of two or more categories associated with the second user as a function of the prompt and the response.

2. (canceled)

3. The system of claim 1 wherein the controller further comprises a user interface configured to allow a user to select the prompt and the response from a plurality of prompts and responses for submission to the deep learning processing system for input to a training algorithm for the deep learning processing system.

4. The system of claim 1 wherein the client system is configured to receive the prompt and to generate an audible output using text to speech conversion.

5. The system of claim 1 wherein the controller system is configured to receive the prompt as a spoken input from the first user and to convert the spoken input to text using speech to text conversion.

6. The system of claim 1 wherein the client system is configured to receive the response as spoken input from the second user and to convert the spoken input into text using speech to text conversion.

7. The system of claim 1 wherein the controller system is configured to receive the response and to generate an audible output using text to speech conversion.

8. The system of claim 1 wherein the deep learning processing system is configured to receive the prompt and to generate a modified prompt in response to the prompt.

9. The system of claim 1 wherein the deep learning processing system is configured to receive the response and to generate a modified prompt in response to the response.

10. The system of claim 1 wherein the deep learning processing system is configured to receive the prompt and to generate a menu of modified prompts in response to the prompt.

11. A process for controlling multicomputer interaction with deep learning, comprising:
generating one or more first user-controllable avatars on an interaction field using one or more algorithms loaded into working memory of a first processor;
receiving movement controls that are controllable by a first user to cause one or more of the first avatars to move to a user-selected location;
receiving a prompt from the first user to generate a prompt for one or more of the first avatars;
generating a second user-controllable avatar on the interaction field using one or more algorithms loaded into working memory of a first processor;
receiving movement controls that are controllable by a second user to cause the second avatar to move to a user-selected location;
receiving a response from the second user to the prompt; and
providing the prompt and the response to a deep learning processing system operating on a third processor and configured to receive the prompt and the response and to process the prompt and the response to generate a score as a function of the prompt and the response and to assign the score to one of two or more categories associated with the second user as a function of the prompt and the response.

12. The process of claim 11 further comprising generating a user interface configured to allow a user to select the prompt and the response from a plurality of prompts and responses for submission to the deep learning processing system for input to a training algorithm for the deep learning processing system.

13. The process of claim 11 further comprising generating an audible output using the prompt and text to speech conversion.

14. The process of claim 11 further comprising receiving the prompt as a spoken input from the first user and converting the spoken input to text using speech to text conversion.

15. The process of claim 11 further comprising receiving the response as spoken input from the second user and converting the spoken input into text using speech to text conversion.

16. The process of claim 11 further comprising receiving the response and generating an audible output using text to speech conversion.

17. The process of claim 11 further comprising receiving the prompt at the deep learning processing system and generating a modified prompt in response to the prompt using the deep learning processing system.

18. The process of claim 11 further comprising receiving the response at the deep learning processing system and generating a modified prompt in response to the response using the deep learning processing system.

19. The process of claim 11 wherein the deep learning processing system is configured to receive the prompt and to generate a menu of modified prompts in response to the prompt.
